(19) United States
(12) Patent Application Publication
(10) Pub. No.: US 2007/0273806 A1
(43) Pub. Date: Nov. 29, 2007

(54) LIQUID CRYSTAL DISPLAY AND ASSEMBLY METHOD THEREOF

(76) Inventors: WEI-CHI LIN, Taipei County (TW); YUN-SHIH WANG, Taoyuan County (TW); KUO-LIANG CHU, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,907

(22) Filed: May 25, 2006

(51) Int. Cl. G02F 1/1333

(52) U.S. Cl. 349/58

(57) ABSTRACT

A liquid crystal display (LCD) including a planar light source module, a main frame, an LCD panel and a front frame is provided. The planar light source module includes a positioning module and a flat light source disposed in thereof. The main frame is assembled with the planar light source module, the LCD panel is disposed in the main frame, and the front frame is assembled with the main frame for fixing the LCD panel. Since the planar light source module is able to be independently disassembled from the main frame, therefore, the LCD has better maintenance and assembly efficiency. Besides, an assembly method of the LCD is provided as well.

### BACKGROUND OF THE INVENTION

1. Field of Invention

The present invention relates to a display and an assembly method thereof, and particularly to a liquid crystal display (LCD) and an assembly method thereof.

2. Description of the Related Art

Along with the modern video technology progress, LCDs are extensively used in display screens of consumer electronic products such as mobile phones, notebook PCs, personal computers (PCs) and personal digital assistants (PDA). Since the LCD panel of an LCD can not illuminate by itself, a planar light source module is required to be disposed under the LCD panel to provide planar light for illuminating the LCD panel, so as to achieve display effect.

Available light source devices of the planar light source modules mainly include a cathode cold fluorescent lamp (CCFL), a light-emitting diode (LED) and a flat fluorescent light (FFL). Wherein, the CCFL is a line light source and the LED is a point light source, therefore both of them require adding a diffuser plate or a light guide plate (LGP) for converting line light source or point light source into planar light source. However, such planar light source, converted from line light source or point light source, has uneven brightness.

In comparison with a CCFL or an LED, the flat fluorescent light (FFL) is planar light source, which can directly reduce the uneven brightness problem. Hence, a flat fluorescent light (FFL) has gradually become the main stream among light source devices.

FIG. 1A is a tri-dimensional diagram of a conventional liquid crystal display (LCD) and FIG. 1B is the tri-dimensional exploded diagram of the liquid crystal display (LCD) in FIG. 1A. Referring to FIGS. 1A and 1B, a conventional LCD 100 is mainly comprised of a back plate 110, a flat fluorescent light 120, a first frame 130, a diffuser plate 140, a second frame 150, a liquid crystal display panel (LCD panel) 160 and a front frame 170. Wherein, the flat fluorescent light 120 is disposed on the back plate 110, the diffuser plate 140 is disposed in the first frame 130 and the LCD panel 160 is disposed in the second frame 150. By sequentially assembling the back plate 110, the first frame 130, the second frame 150 and the front frame 170, the flat fluorescent light 120, the diffuser plate 140 and the LCD panel 160 are fixed together to complete the assembly of the whole LCD 100.

However, the LCD 100 in FIGS. 1A and 1B is formed by assembling each of the above-mentioned elements together in order. Thus, the assembly of the LED 100 is not efficient. If a flat fluorescent light 120 or a diffuser plate 140 is damaged, all the parts of the LCD 100 should be disassembled in reverse order before repairing the damaged flat fluorescent light 120 or the diffuser plate 140. Such a disassembly work is time-consuming and likely to damage the LCD panel 160, even spreading foreign objects to the diffuser plate 140. Further, after maintenance, all elements should be re-assembled together, which lowers the maintenance efficiency of the LCD 100.

In particular, a larger size of an LCD 100 corresponds a larger size of a flat fluorescent light 120, which would largely increase the occurrence of fracture of the flat fluorescent light 120 during assembling or maintaining the LCD 100, and consequently increase the production cost and maintenance cost of the LCD 100.

### SUMMARY OF THE INVENTION

Based on the above described, an object of the present invention is to provide an LCD having a higher assembly and maintenance efficiency.

Another object of the present invention is to provide an assembly method to advance the higher assembly and maintenance efficiency of LCDs.

To achieve the above-described or other objects, the present invention provides an LCD, which includes a planar light source module, a main frame, a LCD panel and a front frame. Wherein, the planar light source module includes a positioning module and a flat fluorescent light disposed in the positioning module. The main frame is assembled with the planar light source module, while the LCD panel is disposed in the main frame and the front frame is assembled with the main frame for fixing the LCD panel.

In an embodiment of the present invention, the positioning module includes a back plate, at least two positioning parts and a plurality of fasteners. The flat fluorescent light is disposed on the back plate, while the two positioning parts are disposed at both opposite sides of the flat fluorescent light, respectively, and the fasteners combine the positioning parts and the back plate for fixing the flat fluorescent light.

In an embodiment of the present invention, each of the positioning parts has an containing space and the periphery of the flat fluorescent light is partially located inside the containing space.

In an embodiment of the present invention, the LCD can further include a cushion, which is disposed between the back plate and the flat light source and the material thereof is selected from the group consisting of high molecular compound of rubber, silica gel, polyurethane foam and a combination thereof.

In an embodiment of the present invention, a first opening is at a side of the above-described main frame, and the planar light source module is assembled with the main frame through the first opening. In addition, the back plate has a baffle matching the first opening for assembly purpose.

In an embodiment of the present invention, the material of the back plate and positioning parts includes metal or dissipation material.

In an embodiment of the present invention, the LCD can further include a sub-frame and an optical film. The sub-frame is disposed between the planar light source module and the main frame, while the optical film is disposed in the sub-frame. Wherein, the sub-frame is assembled with the main frame for fixing the optical film.

In an embodiment of the present invention, a first opening is disposed at a side of the main frame, and a second opening is at the side of the sub-frame corresponding to the first opening. By means of the first opening and the second opening, the planar light source module is assembled with the main frame. Besides, the back plate has a baffle in associate with the first opening and the second opening.

In an embodiment of the present invention, the optical film is selected from the group consisting of diffuser plate, prism plate, light enhancing plate and a combination thereof.

To achieve the above-described or other objects, the present invention further provides a method for assembling LCDs. The method includes: providing a planar light source module, which has a positioning module and a flat light source disposed in the positioning module; providing a main frame and assembling the main frame with the planar light source module; providing an LCD panel and placing the LCD panel in the main frame; and providing a front frame and assembling the front frame with the main frame for fixing the LCD panel.

In an embodiment of the present invention, the positioning module includes a back plate, at least two positioning parts and a plurality of fasteners. To provide the planar light source module, the following steps are included: providing a back plate; disposing the flat light source on the back plate; providing positioning parts and placing the same at both opposite sides of the flat light source; providing fasteners and combining the positioning parts and the back plate for fixing the flat light source.

In an embodiment of the present invention, each of the positioning parts has an containing space and the periphery of the flat light source is partially located inside the containing space.

In an embodiment of the present invention, a cushion is further provided, which is disposed between the back plate and the flat light source, and the material of the cushion is selected from the group consisting of high molecular compound of rubber, silica gel, polyurethane foam and a combination thereof.

In an embodiment of the present invention, a first opening is at a side of the main frame, and the planar light source module is assembled with the main frame through the first opening. The back plate has a baffle matching the first opening for assembly purpose.

In an embodiment of the present invention, the material of the back plate and positioning parts includes metal or dissipation material.

In an embodiment of the present invention, a sub-frame is further provided and the sub-frame is disposed between the planar light source module and the main frame; the optical film is provided and disposed in the sub-frame. Wherein, the sub-frame is assembled with the main frame for fixing the optical film.

In an embodiment of the present invention, a first opening is at a side of the main frame, and a second opening is disposed at the side of the sub-frame corresponding to the first opening. By means of the first opening and the second opening, the planar light source module is assembled with the main frame. Besides, the back plate has a baffle in associate with the first opening and the second opening.

In an embodiment of the present invention, the optical film is selected from the group consisting of diffuser plate, prism plate, light enhancing plate and a combination thereof.

In summary, in the LCD and the assembly method thereof provided by the present invention, since the planar light source module is independently assembled with the main frame, therefore, if the planar light source module is damaged, only the planar light source module needs to be disassembled so as to achieve a higher maintenance efficiency. Besides, since the flat light source is fixed in the positioning module of the planar light source module, during disassembling the planar light source module from the main frame, the fracture chance of the flat light source caused by collision can be largely reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1A is a tri-dimensional diagram of a conventional liquid crystal display (LCD).

FIG. 1B is the tri-dimensional exploded diagram of the liquid crystal display (LCD) in FIG. 1A.

FIG. 2A is a tri-dimensional diagram of an LCD according to the first embodiment of the present invention.

FIG. 2B is the tri-dimensional exploded diagram of the liquid crystal display (LCD) in FIG. 2A.

FIG. 3A is a tri-dimensional diagram of the LCD in FIG. 2A from a different point of view.

FIG. 3B is the partial exploded diagram of the LCD in FIG. 3A.

FIG. 4A is an enlarged diagram of the planar light source module in FIG. 2A.

FIG. 4B is the tri-dimensional exploded diagram of the planar light source module in FIG. 4A.

FIG. 5 is a flowchart for assembling a planar light source module according to an embodiment of the present invention.

FIG. 6 is a flowchart for assembling an LCD according to an embodiment of the present invention.

FIG. 7A and FIG. 7B are tri-dimensional diagrams of another main frame and another back plate according to the first embodiment of the present invention.

FIG. 8A is a tri-dimensional diagram of another liquid crystal display (LCD) according to the first embodiment of the present invention.

FIG. 8B is the partial exploded diagram of the liquid crystal display (LCD) in FIG. 8A.

FIG. 9A is a tri-dimensional diagram of an LCD according to the first embodiment of the present invention.

FIG. 9B is the tri-dimensional exploded diagram of the liquid crystal display (LCD) in FIG. 9A.

FIG. 10 is a tri-dimensional diagram of another sub-frame according to the second embodiment of the present invention.

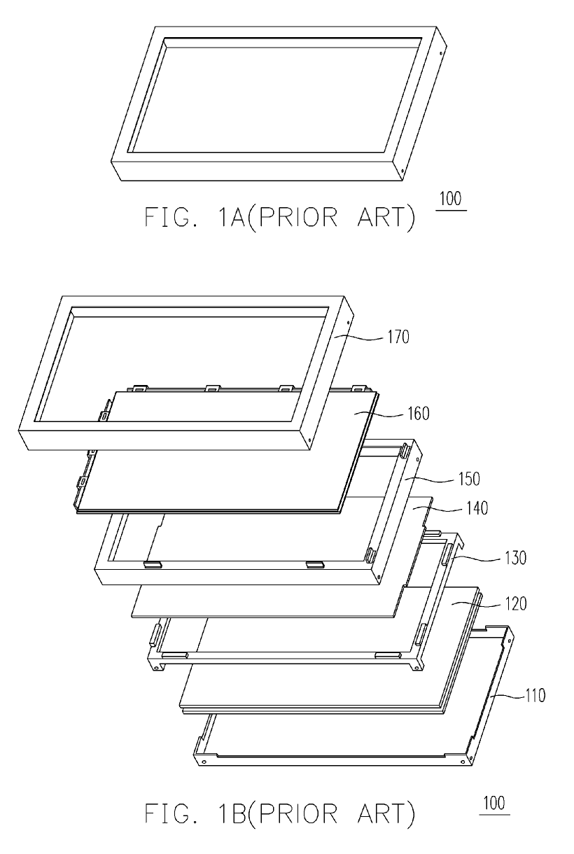

### DESCRIPTION OF THE EMBODIMENTS

### The First Embodiment

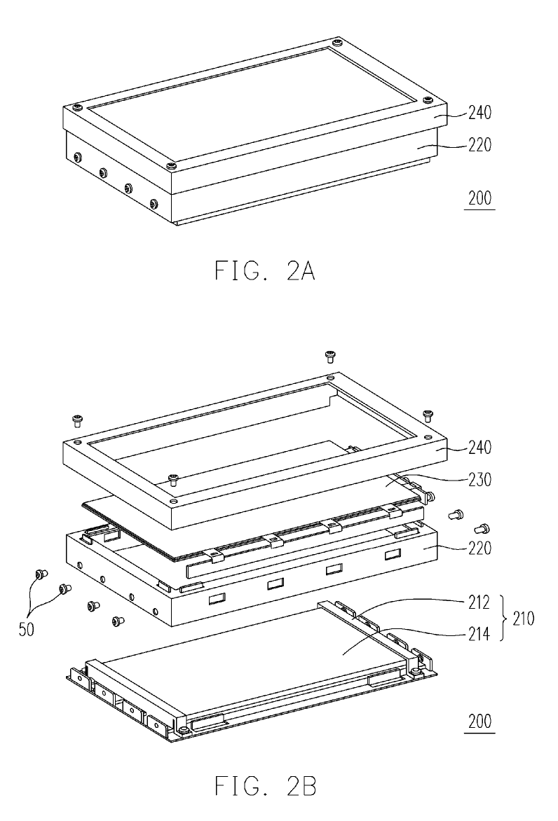

FIG. 2A is a tri-dimensional diagram of an LCD according to the first embodiment of the present invention and FIG. 2B is the schematic exploding perspective view of the LCD in FIG. 2A. Referring to FIGS. 2A and 2B, an LCD 200 of the present invention includes a planar light source module 210, a main frame 220, an LCD panel 230 and a front frame 240. Wherein, the planar light source module 210 includes a positioning module 212 and a flat light source 214 disposed in the positioning module 212. The main frame 220 is assembled with the planar light source module 210, while the LCD panel 230 is disposed in the main frame 220 and the front frame 240 is assembled with the main frame 220 for fixing the LCD panel 230.

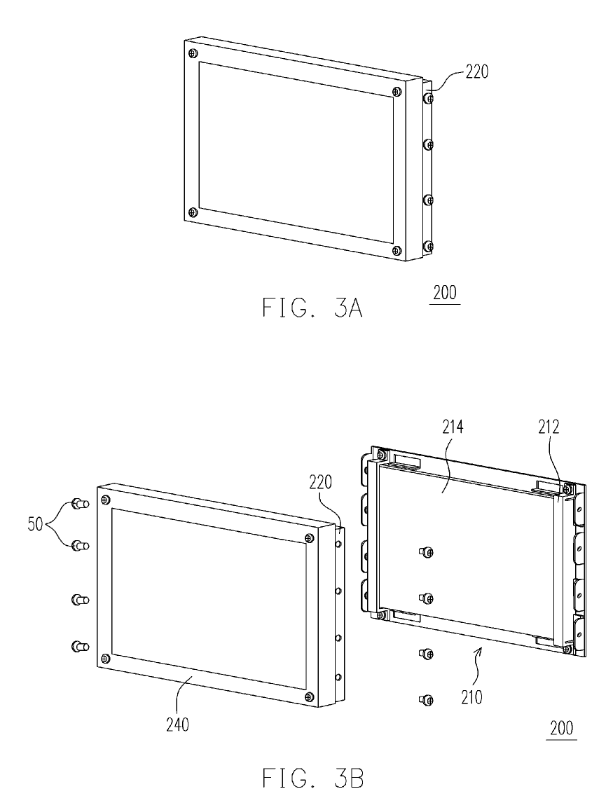

FIG. 3A is a tri-dimensional diagram of the LCD in FIG. 2A from a different point of view and FIG. 3B is the partial exploded diagram of the LCD in FIG. 3A. Referring to FIGS. 3A and 3B, since the planar light source module 210 is independently assembled with the main frame 220, therefore, if the flat light source 214 of the planar light source module 210 is damaged, only the planar light source module 210 needs to be disassembled without the need of disassembling all the parts of the LCD 200, which can advance maintenance efficiency.

Besides, since the flat light source 214 is fixed in the positioning module 212 of the planar light source module 210, thus, during disassembling the planar light source module 210 from the main frame 220, the flat light source 214 is avoided from being directly touched, which largely reduces the fracture chance of the flat light source 214.

Note that the planar light source module 210 is assembled with the main frame 220 by, for example, a plurality of screws 50 in the embodiment. However, the present invention does not limit the assemble manner of the planar source module 210 and the main frame 220. For example, the planar light source module 210 can be pushing pawls, bent pawls, sliding slot fixing, plug slot fixing or other appropriate parts to assemble with the main frame 220.

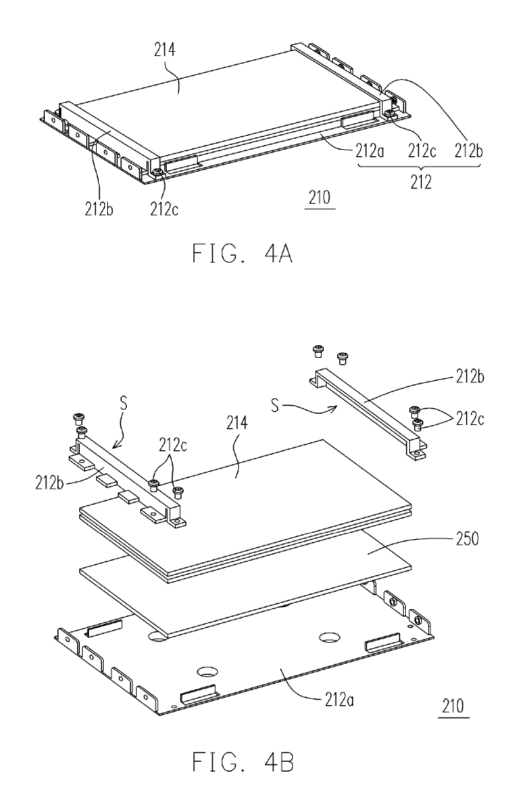

FIG. 4A is an enlarged diagram of the planar light source module in FIG. 2A and FIG. 4B is the tri-dimensional exploded diagram of the planar light source module in FIG. 4A. Referring to FIGS. 4A and 4B, in the embodiment, the positioning module 212 of the planar light source module 210 includes a back plate 212a, two positioning parts 212b and a plurality of fasteners 212c. The flat light source 214 is disposed on the back plate 212a, while the two positioning parts 212b are disposed at both opposite sides of the flat light source 214, respectively, and the fasteners 212c combine the positioning parts 212b and the back plate 212a for fixing the flat light source 214.

In more detail, each positioning part 212b has an containing space S; when the positioning part 212b is combined with the back plate 212a, the periphery of the flat light source 214 is partially located inside the containing space S, so as to position and fix the flat light source 214. In addition, the fasteners 212c are, for example, screws. However, the present invention does not limit the type of screws; for example, pushing pawls, bent pawls, sliding slot fixing, plug slot fixing or other appropriate parts as fasteners can be used to combine the positioning part 212b with the back plate 212a for fixing the flat light source 214.

Note that the major function of the positioning module 212 is for positioning and fixing the flat light source 214, and the positioning module 212 is able to be assembled with the main frame 220 independently for higher assembly efficiency. The above-described method for fixing the flat light source 214 by the back plate 212a, the positioning part 212b and the fasteners 212c is considered as exemplary to explain the spirit of the present invention. Anyone skilled in the art should be capable of making modifications to meet the demand thereof, which is without departing from the scope or spirit of the invention.

Referring to FIGS. 4A and 4B again, to avoid directly hitting the flat light source 214 by the back plate 212a during carrying the LCD 200, the LCD 200 of the embodiment can further include a cushion 250 disposed between the flat light source 214 and the back plate 212a, which reduces the fracture chance of the flat light source 214 caused by collision.

Furthermore, the cushion 250 is made of a material with certain viscosity and impact resistance, and the material can be high molecular compound, such as rubber, silica gel, polyurethane foam and the combination thereof. In addition, a cushion 250 with high thermal conductivity is preferred to advance the dissipation performance of the flat light source 214. Moreover, the material of the back plate 212a and the positioning part 212b can be metal or dissipation material to further increase the dissipation effect of the flat light source 214. In the embodiment, the material of the back plate 212a and the positioning part 212b is aluminum or aluminum alloy. Except for the high thermal conductivity, the lighter weight of these materials is another advantage for an LCD 200 to meet the current market trend of low-weight.

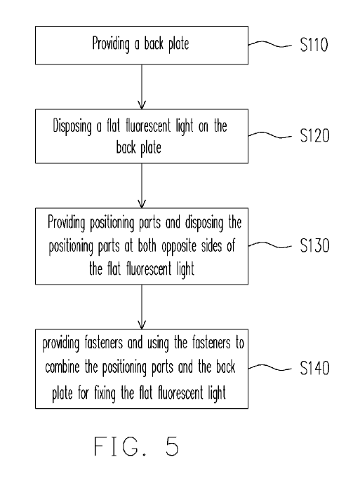

In the following, flowcharts are used to explain the method for assembling the planar light source module 210 and the LCD 200. FIG. 5 is a flowchart for assembling a planar light source module according to an embodiment of the present invention. Referring to FIG. 5, FIG. 4A and FIG. 4B, the method for assembling the planar light source module 210 includes the steps as follows. First, in step S110, a back plate 212a is provided. Next, in step S120, a flat light source 214 is disposed on the back plate 212a. In an embodiment with a cushion 250, the step S120 is to dispose the cushion 250 on the back plate 212a, followed by disposing the flat light source 214 on the cushion 250 but over the back plate 212a.

Next, in step S130, the positioning parts 212b are provided and disposed at both opposite sides of the flat light source 214. After that, as illustrated in step S140, fasteners 212c are provided, and the positioning parts 212b and the back plate 212a are combined by the fasteners 212c to fix the flat light source 214. In this way, the planar light source module 210 is completely assembled.

Note that the major feature of the method for assembling the planar light source module 210 in the embodiment is to combine the parts of the planar light source module 210 (for example, the back plate 212a, the positioning parts 212b and the fasteners 212c) for fixing the flat light source 214 so as to form the planar light source module 210. Anyone skilled in the art can modify the parts in the positioning module 212 and further revise the assembly method referring to the above-described scheme, which will not depart from the scope or spirit of the invention.

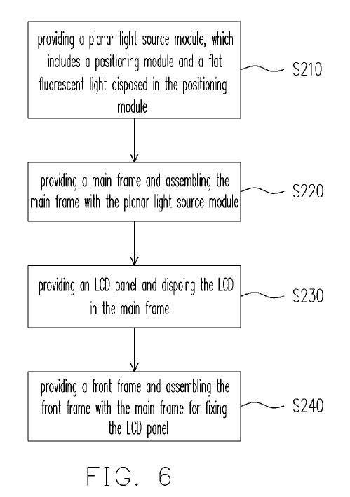

FIG. 6 is a flowchart for assembling an LCD according to an embodiment of the present invention. Referring to FIG. 6, FIG. 2A and FIG. 2B, the method for assembling the LCD 200 includes the steps as follows. First, in step S210, a planar light source module 210 is provided, which includes a positioning module 212 and a flat light source 214 disposed in the positioning module 212. The present invention neither limits the structures of the planar light source module 210 to the ones shown in FIG. 2B, nor limits the parts of the positioning module 212.

Next, in step S220, a main frame 220 is provided, followed by assembling the main frame 220 and the planar light source module 210. Then, in step S230, an LCD panel 230 is provided, followed by disposing the LCD panel 230 into the main frame 220. After that, in step S240, a front frame 240 is provided, followed by assembling the front frame 240 and the main frame 220 for fixing the LCD panel 230. At this point, the LCD 200 is completely assembled.

In the above-described assembly, the direction of combining the planar light source module 210 with the main frame 220 can be, for example, a front assembly, but the present invention does not limit the direction of combining the planar light source module 210 with the main frame 220. In the following, a side assembly to combine the planar light source module 210 with the main frame 220 is described in associate with figures.

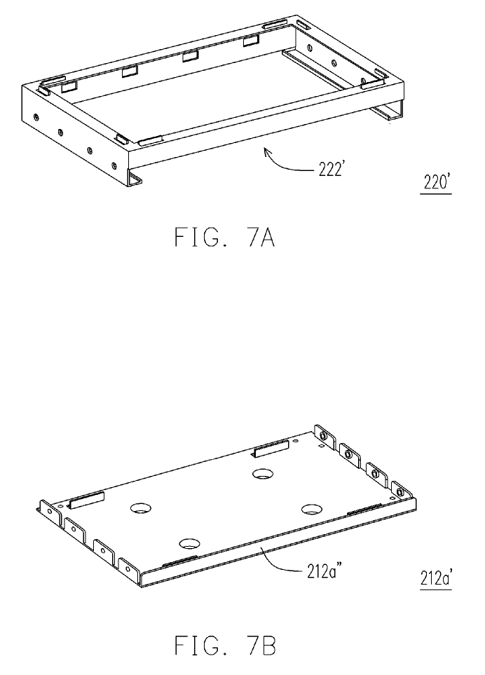

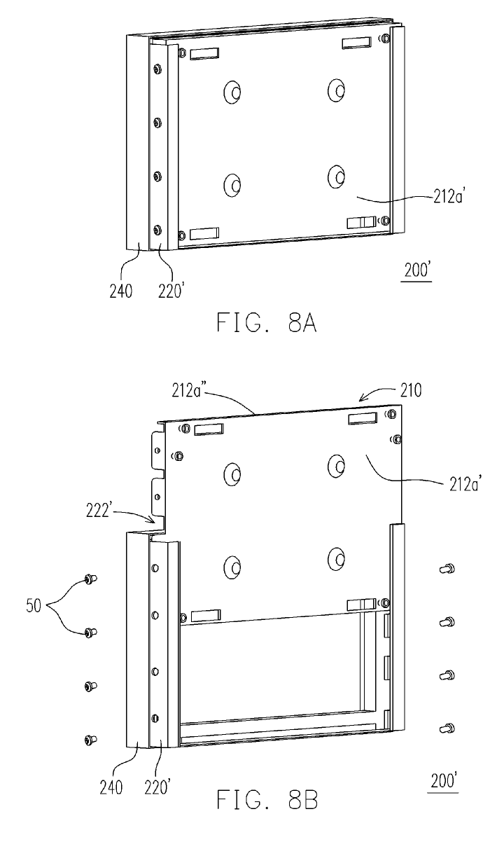

FIG. 7A and FIG. 7B are tri-dimensional diagrams of another main frame and another back plate according to the first embodiment of the present invention; FIG. 8A is a tri-dimensional diagram of another LCD according to the first embodiment of the present invention; and FIG. 8B is the partial exploded diagram of the LCD in FIG. 8A. Referring to FIGS. 7A, 7B, 8A and 8B, the LCD 200′, the main frame 220′ and the back plate 212a′ in the figures are similar to the LCD 200 in FIG. 2A, the main frame 220 in FIG. 2B and the back plate 212a′ in FIG. 4B, respectively; the differences are: a first opening 222′ is at a side of the main frame 220′, and the back plate 212a′ has a baffle 212a″ to match the first opening 222′. Thus, the planar light source module 210 can be assembled with the main frame 220′ together by a side assembly method through the first opening 222′.

To further advance the display quality of an LCD, the present invention further disposes an optical film between the flat light source and the LCD panel. In the following, another embodiment is described in associate with figures.

### The Second Embodiment

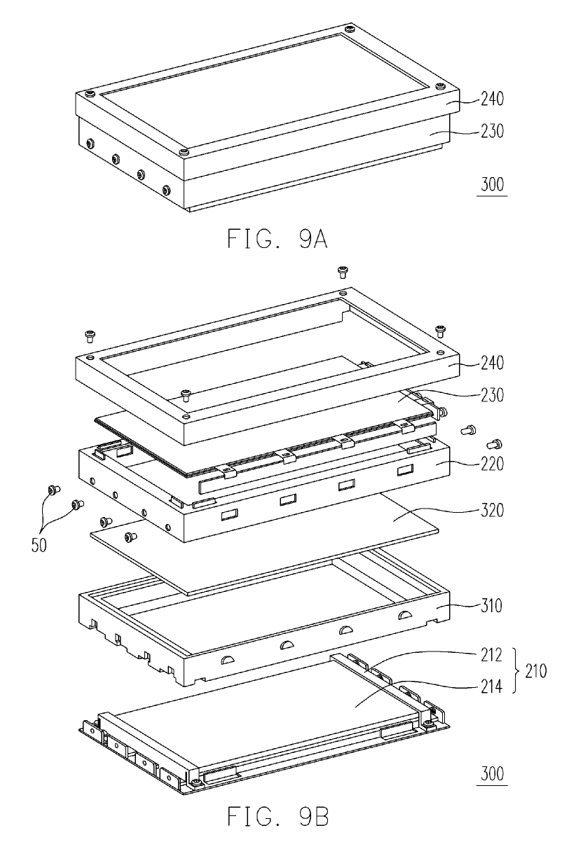

FIG. 9A is a tri-dimensional diagram of an LCD according to the first embodiment of the present invention and FIG. 9B is the tri-dimensional exploded diagram of the LCD in FIG. 9A. Referring to FIGS. 9A and 9B, the LCD 300 of the embodiment is similar to the LCD 200 of the first embodiment (as shown in FIGS. 2A and 2B), except that the LCD of the embodiment further includes a sub-frame 310 and an optical film 320. The optical film 320 is disposed in the sub-frame 310, the sub-frame 310 is disposed between the planar light source module 210 and the main frame 220, and the sub-frame 310 is assembled with the main frame 220 for fixing the optical film 320.

In the embodiment, the optical film 320 is one of a diffuser plate, a prism plate, a light enhancing plate or a combination thereof, by which the planar light source module 210 is able to provide the LCD panel 230 with a planar light source with more even and higher luminance, which leads to a better display quality.

Besides, in the embodiment, the planar light source module 210, main frame 220 and the sub-frame 310 are assembled together by the screws 50; but the present invention does not limit assembly manners. In addition, the optical film 320 can be directly disposed in the main frame and rest between the LCD panel 230 and the flat light source 214 so as to save the step of disposing the sub-frame 310.

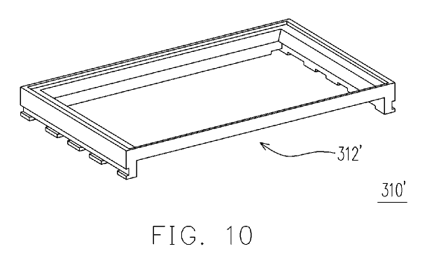

Note that although in the LCD 300, the planar light source module 210 is assembled with the main frame 220 and the sub-frame 310 by a front assembly, however, it can be assembled by the side assembly. FIG. 10 is a tri-dimensional diagram of another sub-frame according to the second embodiment of the present invention, while FIG. 7A and FIG. 7B are tri-dimensional diagrams of a main frame and a back plate to match the sub-frame. Referring to FIGS. 10, 7A and 7B, the sub-frame 310′ is similar to the sub-frame 310 in FIG. 9B, except that the sub-frame 310′ has a second opening 312′, wherein the second opening 312′ corresponds to, for example, the first opening 222′ in FIG. 7A. In this way, the planar light source module 210 can take a side assembly to combine the main frame 220′ by using the first opening 222′ and the second opening 312′.

In summary, the LCD and the assembly method thereof of the present invention has at least the following advantages:

Since the planar light source module is independently assembled with the main frame of an LCD, thus, when the flat light source of the planar light source module is damaged, only the planar light source module needs to be disassembled without disassembling the entire LCD's components in order, which can advance the maintenance efficiency and the assembly efficiency.

During disassembling the planar light source module, there is no need to disassemble the LCD panel or optical films thereof, which can largely reduce the possibility of damaging of the LCD panel and avoid the entry of foreign particles that may contaminate optical films.

Since the flat light source is fixed in the positioning module of the planar light source module, hence, during disassembling the planar light source module, the flat light source can avoid from being directly touched, which reduces the chance of fracture of the flat light source.

By disposing a cushion between the flat light source and the back plate, the chance of breaking the flat light source caused by a direct collision between the flat light source and the back plate can be reduced, and the dissipation performance of the flat light source can be improved.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A liquid crystal display (LCD), comprising:
a planar light source module, comprising:
a positioning module;
a flat light source, disposed in the positioning module;
a main frame, assembled with the planar light source module;
an LCD panel, disposed in the main frame; and
a front frame, assembled with the main frame for fixing the LCD panel.

2. The LCD as recited in claim 1, wherein the positioning module comprises:
a back plate, on which the flat light source is disposed;
at least two positioning parts, disposed at both opposite sides of the flat light source; and
a plurality of fasteners, combining the positioning parts and the back plate for fixing the flat light source.

3. The LCD as recited in claim 2, wherein each positioning part has an containing space, and the periphery of the flat light source is partially located inside the containing space.

4. The LCD as recited in claim 2 further comprising a cushion, disposed between the back plate and the flat light source.

5. The LCD as recited in claim 4, wherein the material of the cushion is selected from the group consisting of high molecular compound of rubber, silica gel, polyurethane foam and a combination thereof.

6. The LCD as recited in claim 2, wherein a first opening is disposed at a side of the main frame, the planar light source module is assembled with the main frame by means of the first opening, and the back plate has a baffle in associate with the first opening.

7. The LCD as recited in claim 2, wherein the material of the back plate and the positioning parts comprises metal or dissipation material.

8. The LCD as recited in claim 2 further comprising:
a sub-frame, disposed between the planar light source module and the main frame; and
an optical film, disposed in the sub-frame,
wherein the sub-frame is assembled with the main frame for fixing the optical film.

9. The LCD as recited in claim 8, wherein a first opening is disposed at a side of the main frame, a second opening is disposed at the side of the sub-frame corresponding to the first opening, the planar light source module is assembled with the main frame by means of the first opening and the second opening, and the back plate has a baffle to match the first opening and the second opening.

10. The LCD as recited in claim 8, wherein the optical film is selected from the group consisting of diffuser plate, prism plate, light enhancing plate and a combination thereof.

11. An assembly method of a liquid crystal display (LCD), comprising:
providing a planar light source module, wherein the planar light source module has a positioning module, and a flat light source disposed in the positioning module;
providing a main frame, being assembled with the planar light source module;
providing an LCD panel, being disposed in the main frame; and
providing a front frame, being assembled with the main frame for fixing the LCD panel.

12. The assembly method of an LCD as recited in claim 11, wherein the positioning module comprises a back plate, at least two positioning parts and a plurality of fasteners; the step of providing the planar light source module comprises the following steps:
providing the back plate;
disposing the flat light source on the back plate;
providing the positioning parts and disposing the positioning parts at both opposite sides of the flat light source; and
providing the fasteners and combining the positioning parts with the back plate for fixing the flat light source.

13. The assembly method of an LCD as recited in claim 12, wherein each positioning part has an containing space and the periphery of the flat light source is partially located inside the containing space.

14. The assembly method of an LCD as recited in claim 12 further comprising providing a cushion, disposed between the back plate and the flat light source.

15. The assembly method of an LCD as recited in claim 14, wherein the material of the cushion is selected from the group consisting of high molecular compound of rubber, silica gel, polyurethane foam and a combination thereof.

16. The assembly method of an LCD as recited in claim 12, wherein a first opening is at a side of the main frame, the planar light source module is assembled with the main frame by means of the first opening, and the back plate has a baffle in associate with the first opening.

17. The assembly method of an LCD as recited in claim 12, wherein the material of the back plate and the positioning parts comprises metal or dissipation material.

18. The assembly method of an LCD as recited in claim 12 further comprising:
providing a sub-frame, disposed between the planar light source module and the main frame; and
providing an optical film, disposed in the sub-frame,
wherein the sub-frame is assembled with the main frame for fixing the optical film.

19. The assembly method of an LCD as recited in claim 18, wherein a first opening is disposed at a side of the main frame, a second opening is disposed at the side of the sub-frame corresponding to the first opening, the planar light source module is assembled with the main frame by means of the first opening and the second opening, and the back plate has a baffle to match the first opening and the second opening.

20. The assembly method of an LCD as recited in claim 18, wherein the optical film is selected from the group consisting of a diffuser plate, a prism plate, a light enhancing plate and a combination thereof.
